(19) United States
(12) Patent Application Publication
(10) Pub. No.: US 2001/0056551 A1
(43) Pub. Date: Dec. 27, 2001

(54) Energy supply device and circuit configuration that includes the energy supply device

(76) Inventors: Peter Hofreiter, Otterfing (DE); Christian Aumuller, Weilheim (DE)

Correspondence Address: LERNER AND GREENBERG, P.A., Post Office Box 2480, Hollywood, FL, 33022-2480, US

(21) Appl. No.: 09/861,762

(22) Filed: May 21, 2001

Related U.S. Application Data
(63) Continuation of application No. PCT/DE99/033673, filed on Nov. 18, 1999.

(30) Foreign Application Priority Data
Nov. 19, 1998 (DE) 198 53 448.5

(51) Int. Cl. G06F 1/26

(52) U.S. Cl. 713/300

(57) ABSTRACT

An energy supply device having an intermediate energy store, a main energy store and a circuit device is provided. The circuit device contains at least two output states, whereby the intermediate energy store is connected to an energy supply input in a first output state and to the main energy store, which is connected to the energy supply output, in a second output state.

### BACKGROUND OF THE INVENTION

Field of the Invention

The invention relates to an energy supply device and a circuit configuration that includes the energy supply device.

Patent Abstract of Japan Vol. 10 Nr. 267 (E-462) and JP 61 16 1967 teach a switched-mode power supply wherein an intermediate energy storage device is charged from an energy supply input by way of a switching device in a first output state. In a second output state, the energy of the intermediate energy store is transferred to a main energy store.

Published, European Patent Application EP 08 18 875 A2 likewise teaches a voltage supply which can be disposed on a semiconductor chip.

There is a growing demand for providing data processing circuits with reliable energy supplies. The origin of this demand is the increasing necessity in data processing technology to check whether or not an operation of a data processing circuit is permitted. In step with the consequent identification process, i.e. the authentication and monitoring of whether or not the operation is permitted, it is increasingly attempted to circumvent such measures. One way to reach operations or data in a data processing device without permission is to determine the changing energy consumption of the data processing device during an authorized operation. From the changes, access to specific processes or data is obtained without independent authorization.

### SUMMARY OF THE INVENTION

It is accordingly an object of the invention to provide an energy supply device and a circuit configuration that includes the energy supply device which overcome the above-mentioned disadvantages of the prior art devices and methods of this general type, in which it is impossible to deduce processes or data in a data processing device by monitoring the energy consumption.

With the foregoing and other objects in view there is provided, in accordance with the invention, an energy supply device. The energy supply device contains an intermediate energy store, an energy supply input, an energy supply output, a main energy store connected to the energy supply output, an energy discharge circuit, and a switching device connected to the intermediate energy store, the main energy store, the energy supply input, and the energy discharge circuit. The switching device has output states including a first output state, a second output state, and a third output state. The intermediate energy store is connected to the energy supply input in the first output state, and the intermediate energy store is connected to the main energy store in the second output state of the switching device. The switching device assumes the third output state subsequent to the second output state in which the energy discharge circuit is connected to the intermediate energy store through the switching device.

Owing to the decoupling of the charged intermediate energy store from the energy supply input and the transfer to the main energy store, the energy consumption that can be observed at the energy supply input is independent of the instantaneous value of the energy consumption which can be observed at the energy supply output, i.e. the consumption which is caused by the data processing device.

The suggested measures also serve to suppress an instantaneous value of the energy consumption at the energy supply output, i.e. of the data processing device.

In accordance with an added feature of the invention, a random-check generator is connected to the energy discharge circuit. The random-check generator specifies a level of voltage to which the energy discharge circuit discharges to the intermediate energy store.

In accordance with an additional feature of the invention, the switching device is one of a plurality of switching devices. The intermediate energy store is one of a plurality of intermediate energy stores each connected to a respective one of the switching devices and through the switching devices each of the intermediate energy stores is connected to the energy supply input and the main energy store parallel to each other.

In accordance with another feature of the invention, the plurality of intermediate energy stores are connected to the energy supply input at different predetermined times.

In accordance with a further feature of the invention, the plurality of intermediate energy stores are connected to the main energy store simultaneously.

With the foregoing and other objects in view there is provided, in accordance with the invention, a circuit configuration containing an energy supply device. The energy supply device contains an intermediate energy store, an energy supply input, an energy supply output, a main energy store connected to the energy supply output, an energy discharge circuit, and a switching device connected to the intermediate energy store, the main energy store, the energy supply input, and the energy discharge circuit. The switching device has output states including a first output state, a second output state and a third output state. The intermediate energy store is connected to the energy supply input in the first output state and the intermediate energy store is connected to the main energy store in the second output state of the switching device. The switching device assumes the third output state subsequent to the second output state in which the energy discharge circuit is connected to the intermediate energy store through the switching device. A data processing device is connected to the energy supply output.

In accordance with an added feature of the invention, the switching device is driven with a frequency that is less than or equal to a maximum operating frequency of the data processing device.

In accordance with a concomitant feature of the invention, the circuit configuration is constructed in an integrated form on a semiconductor chip.

Other features which are considered as characteristic for the invention are set forth in the appended claims.

Although the invention is illustrated and described herein as embodied in an energy supply device and a circuit configuration that includes this energy supply device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

FIG. 1 is a block circuit diagram of a first exemplifying embodiment according to the invention;

FIG. 2 is a block circuit diagram of a development of the exemplifying embodiment shown in FIG. 1;

FIG. 3 is a block circuit diagram of another development of the inventive exemplifying embodiment shown in FIG. 1; and

FIG. 4 is a circuit diagram of a second exemplifying embodiment.

### DESCRIPTION OF PREFERRED EMBODIMENTS

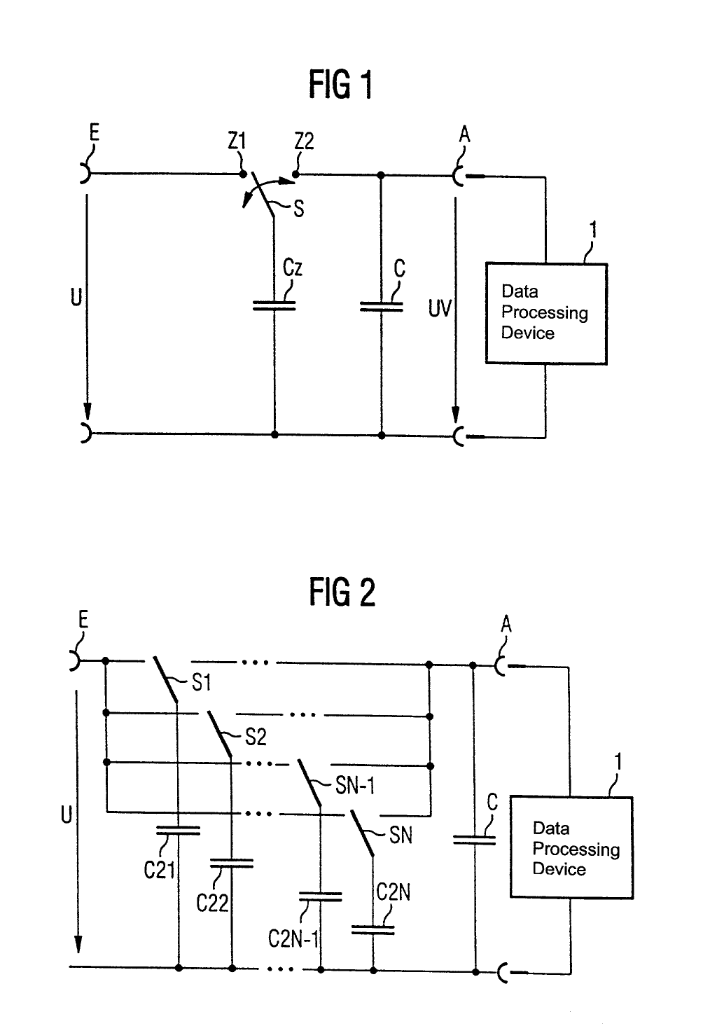

In all the figures of the drawing, sub-features and integral parts that correspond to one another bear the same reference symbol in each case. Referring now to the figures of the drawing in detail and first, particularly, to FIG. 1 thereof, there is shown a first exemplifying embodiment of the invention. Here, it can be seen that a voltage U stands at an input E, the voltage U is fed to a switch S when the switch S assumes a first output state Z1. In the first output state, the voltage U is fed to a capacitor CZ. The capacitor CZ is thus charged to a value of the voltage U at the input E. When the switch S assumes a second state Z2, the capacitor CZ is no longer connected to the input E but rather to a capacitor C, which is charged by the capacitor CZ in turn. At an output A stands the voltage V, which serves as a supply voltage for a data processing device 1 which is also connected at the output A. The operation of the data processing device 1 consumes energy, thereby discharging the capacitor C. It is thus necessary for the switch S to alternate back into the first state Z1, so that the capacitor CZ is recharged and in turn recharges the capacitor C when the switch S switches back into the second state Z2 again.

The data processing device 1 should be driven at a clock rate T. If the changeover frequency that is used to repeatedly recharge the capacitor C is less than twice the clock rate T, it is impossible to deduce the current with which the data processing device 1 is driven by way of the capacitor C from a charge current that charges the capacitor CZ.

Given a simple low-pass filter, the high frequencies are damped, which makes it more difficult to deduce the function, though the actual current characteristic can be discovered by corresponding amplification.

In an embodiment as a sampling filter, it is possible to purposely violate the sampling theorem, and thus to substantially complicate the reconstruction of the original current characteristic, using a changeover frequency (sampling frequency) of less than twice the clock frequency of the circuit. The desired falsification is greater the lower the changeover frequency is in relation to the clock frequency.

The reconstruction can be additionally complicated by varying the changeover frequency over time.

FIG. 2 shows a development of the exemplifying embodiment shown in FIG. 1. Identical or analogous elements are provided with the same reference characters in FIG. 2. In this development, a number N of capacitors C21 to C2N are provided, which are charged with the voltage U from the voltage input E by way of switches S1 to SN, respectively. It is provided as a first possibility that the capacitors C21 to C2N be charged with the input voltage U simultaneously and then successively connected to the capacitor C in a parallel fashion. This reduces a voltage ripple at the capacitor C without more information being transferred to the input E. Another possibility is to connect the capacitors C21 to C2N to the input E and the capacitor C in a progressively more complex order. In both instances, the charge current that is drawn from the input voltage is evened out, i.e. smoothed. In addition, in each case it can be provided that the configuration for the data processing device 1 is operated as a voltage regulator. In this case, the clock rate T is controlled in dependence upon the current consumption, i.e. the supply voltage UV.

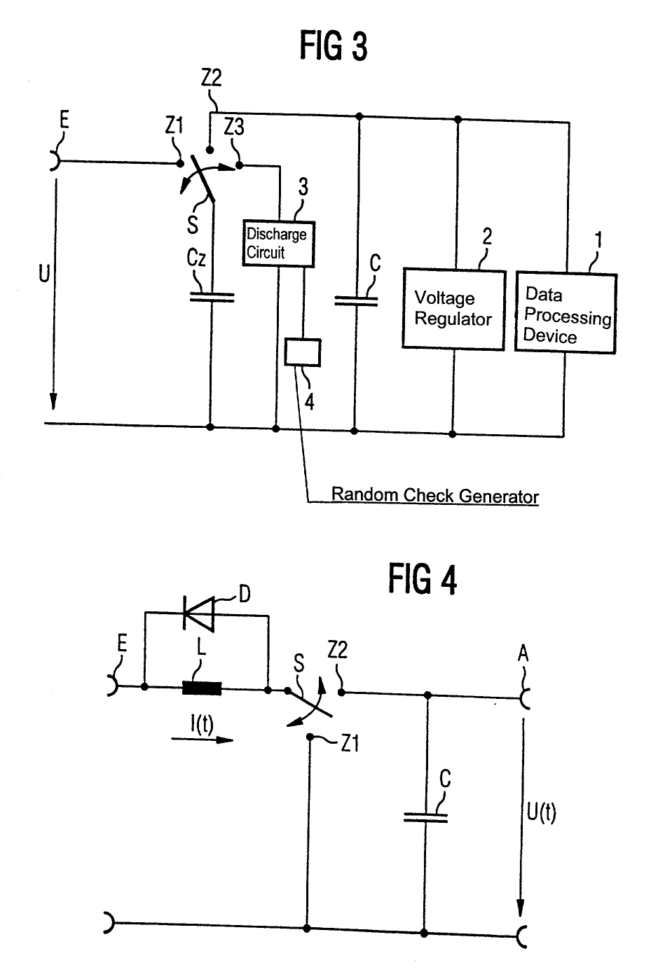

FIG. 3 shows an additional development of the exemplifying embodiment in FIG. 1. In this development, the switch S contains a third state Z3. In addition, a parallel voltage regulator 2 is provided parallel to the capacitor C and the data processing device 1. The difference in operation between the configuration represented in FIG. 3 and that in FIG. 1 is that, after the charge that is stored in the capacitor CZ is transferred to the capacitor C, the switch S assumes the third state Z3. In this position, the capacitor CZ is connected in parallel to a discharge circuit 3. The discharge circuit 3 now discharges the capacitor CZ to a predetermined value. Next, the switch S reverts to first state Z1, so that the capacitor CZ is thus connected to the input E and is recharged by the input voltage U. In this way, the capacitor CZ contains a predetermined state prior to the recharging process, so that it is always charged with the same charging current from the input voltage U.

It is also possible to set the level of the predetermined voltage to which the discharging proceeds using a random-check generator 4.

All three developments of the first inventive exemplifying embodiment can be expediently realized as an integrated circuit on a semiconductor chip. For instance, in the data processing device 1 that requires a supply voltage of two volts and is operated with an average power loss of 2 mW, given a switching frequency of 1 MHz an input voltage of 3 volts is required, and for the capacitor CZ a capacitance of 1 nF is required. A current of 1 mA is carried therein. In this case, the switch S is realized by a conventional electronic switch. The circuit configuration is preferred for integrated circuits that are produced with a technology that utilizes ferroelectric dielectrics. In this case, the dielectricity constant that is used can be elevated relative to conventional dielectricity constants, so that a small area is needed for a predetermined capacity.

FIG. 4 shows a second exemplifying embodiment. In this exemplifying embodiment, the capacitor CZ of FIGS. 1 to 3 is replaced by an inductor L. By switching from the first output state Z1 to the second output state Z2, the switch S accomplishes the following. In the first state Z1, a current I(T) is impressed into the inductor L, forming a magnetic field. The magnetic field corresponds to a magnetic energy that is stored by the coil L. When the switch S alternates from the first output state Z1 to the second output state Z2, the coil L is connected to the capacitor C in turn, which is then charged by a charging current to a voltage UV(T) from the magnetic energy that is stored in the inductor L. To prevent over voltages in the changeover from the first output state Z1 to the second output state Z2, what is known as a freewheel diode D must be provided parallel to the inductor L. If it is not possible to integrate the inductor L in the semiconductor chip, it can at least be disposed directly on the surface of the semiconductor chip. The developments in FIG. 2 and FIG. 3 can be transferred to the second exemplifying embodiment accordingly.

We claim:

1. An energy supply device, comprising:
an intermediate energy store;
an energy supply input;
an energy supply output;
a main energy store connected to said energy supply output;
an energy discharge circuit; and
a switching device connected to said intermediate energy store, said main energy store, said energy supply input, and said energy discharge circuit, said switching device having output states including a first output state, a second output state, and a third output state, said intermediate energy store connected to said energy supply input in said first output state, said intermediate energy store connected to said main energy store in said second output state of said switching device, and said switching device assumes said third output state subsequent to said second output state in which said energy discharge circuit is connected to said intermediate energy store through said switching device.

2. The energy supply device according to claim 1, including a random-check generator connected to said energy discharge circuit, said random-check generator specifies a level of voltage to which said energy discharge circuit discharges to said intermediate energy store.

3. The energy supply device according to claim 1, wherein said switching device is one of a plurality of switching devices, said intermediate energy store is one of a plurality of intermediate energy stores each connected to a respective one of said switching devices and through said switching devices each of said intermediate energy stores is connected to said energy supply input and said main energy store parallel to each other.

4. The energy supply device according to claim 3, wherein said plurality of intermediate energy stores are connected to said energy supply input at different predetermined times.

5. The energy supply device according to claim 4, wherein said plurality of intermediate energy stores are connected to said main energy store simultaneously.

6. A circuit configuration, comprising:
an energy supply device containing:
an intermediate energy store;
an energy supply input;
an energy supply output;
a main energy store connected to said energy supply output;
an energy discharge circuit; and
a switching device connected to said intermediate energy store, said main energy store, said energy supply input, and said energy discharge circuit, said switching device having output states including a first output state, a second output state and a third output state, said intermediate energy store connected to said energy supply input in said first output state, said intermediate energy store connected to said main energy store in said second output state of said switching device, and said switching device assuming said third output state subsequent to said second output state in which said energy discharge circuit is connected to said intermediate energy store through said switching device; and
a data processing device connected to said energy supply output.

7. The circuit configuration according to claim 6, wherein said switching device is driven with a frequency that is less than or equal to a maximum operating frequency of said data processing device.

8. The circuit configuration according to claim 6, wherein the circuit configuration is constructed in an integrated form on a semiconductor chip.
